(19) United States
(12) Patent Application Publication
(10) Pub. No.: US 2021/0131397 A1
(43) Pub. Date: May 6, 2021

(54) WATER-FLOW POWER GENERATING APPARATUS

(71) Applicant: MITSUBISHI HEAVY INDUSTRIES, LTD., Tokyo (JP)

(72) Inventors: Hiroyuki Ishida, Tokyo (JP); Shinkichi Tanigaki, Tokyo (JP)

(73) Assignee: MITSUBISHI HEAVY INDUSTRIES, LTD., Tokyo (JP)

(21) Appl. No.: 16/480,834

(22) PCT Filed: Jan. 26, 2018
(86) PCT No.: PCT/JP2018/002507

§ 371 Date: Jul. 25, 2019

(30) Foreign Application Priority Data
Jan. 26, 2017 (JP) 2017-012165

(51) Int. Cl. F03B 13/10; F03B 17/06

(52) U.S. Cl. CPC F03B 13/10; F03B 17/065; F05B 2240/95; F05B 2240/20; F05B 2220/706

(57) ABSTRACT

A water-flow power generating apparatus for generating electricity by a force of a water flow in water includes a main body including one rotor configured to rotate by a force received by blades from a water flow, a generator generating electricity by a rotation force of the rotor, and a pod accommodating the generator; a mooring cable for mooring the main body to a bottom of water; and a connecting mechanism for connecting the mooring cable to the pod. The mooring cable and the pod are relatively movable along a vertical plane orthogonal to a center axis of the rotor. A center of buoyancy of the apparatus main body is on a vertical upper side with respect to a center of gravity of the apparatus main body.

### FIELD

The present invention relates to a water-flow power generating apparatus.

### BACKGROUND

Hitherto, techniques with regard to water-flow power generating apparatuses that generate electricity by utilizing the energy of a water flow (ocean current, tidal current, river current) in oceans or rivers have been known. For example, in Patent Literature 1, an ocean current energy extracting apparatus has been disclosed that includes two or more sets of counter-rotating rotor assemblies. In this apparatus, by rotating each of the rotor assemblies in an opposite direction, the apparatus prevents the apparatus itself from rotating in the water by a reaction force due to the rotation of blades.

In Patent Literature 2, a water-flow power generating apparatus has been disclosed that is moored to the bottom of water with a mooring cable, in which a power generator equipped with a propeller is disposed on an intermediate portion of a shaft connecting a float section at an upper portion and a ballast section at a lower portion. In this apparatus, when the apparatus inclines along a vertical plane orthogonal to a rotation shaft due to a reaction force accompanying the rotation of the propeller, a force toward a side opposite to the inclining direction acts on an apparatus main body by the buoyance acting on the float section and the gravity acting on the ballast section. Thereby, the apparatus main body is prevented from rotating in the water by the reaction force accompanying the rotation of the propeller without using two or more sets of rotor assemblies.

### CITATION LIST

### Patent Literature

Patent Literature 1: Japanese Translation of PCT International Application No. 2014-534375

Patent Literature 2: Japanese Patent Application Laid-open No. 2014-58911

### SUMMARY

### Technical Problem

However, although the water-flow power generating apparatus described in Patent Literature 2 can maintain the attitude of the apparatus main body in the water without using a plurality of rotor assemblies, there are provided the float section at the upper portion of the apparatus main body and the ballast section at the lower portion with the shaft interposed therebetween. Accordingly, the number of parts increases, and the apparatus constitution becomes complicated.

The present invention has been achieved in view of the above circumstances, and an object of the present invention is to maintain the attitude of an apparatus main body stably in the water while intending to simplify the apparatus, in a water-flow power generating apparatus that generates electricity by a rotation force of one rotor.

### Solution to Problem

To solve the problem described above and achieve the object, the present invention is a water-flow power generating apparatus for generating electricity by a force of a water flow when disposed in water. The water-flow power generating apparatus includes an apparatus main body including one rotor configured to rotate by a force received by a plurality of blades from a water flow, a generator connected to a rotation shaft of the rotor to generate electricity by a rotation force of the rotor, and a pod that accommodates the generator; a mooring cable for mooring the apparatus main body to a bottom of water; and a connecting mechanism for connecting the mooring cable to the pod. The connecting mechanism connects the mooring cable and the pod so that the mooring cable and the pod are relatively movable along a vertical plane orthogonal to a center axis of the rotation shaft of the rotor. A center of buoyancy of the apparatus main body is on a vertical upper side with respect to a center of gravity of the apparatus main body. When the apparatus main body inclines along the vertical plane due to reaction torque acting on the apparatus main body in a direction opposite to a rotation direction of the rotor, rotation torque in the rotation direction of the rotor acts on the apparatus main body by buoyancy at the center of buoyancy and gravity at the center of gravity.

The water-flow power generating apparatus according to the present invention connects, by the connecting mechanism, the mooring cable to moor the apparatus main body to a bottom of water and the pod so as to be movable relatively to each other along the vertical plane orthogonal to the center axis of the rotation shaft of the rotor, whereby the inclination of the apparatus main body along this vertical plane is permitted. Moreover, in the water-flow power generating apparatus according to the present invention, the center of buoyancy of the apparatus main body is disposed on the vertical upper side with respect to the center of gravity, and when the apparatus main body inclines, by the rotation torque that acts on the apparatus main body toward the rotation direction of the rotor, i.e., a direction opposite to the reaction torque by buoyancy at the center of buoyancy and gravity at the center of gravity, it is possible to prevent the apparatus main body from rotating due to the reaction torque. As a result, as compared with a constitution to dispose a float section on an upper part of an apparatus main body and a ballast section on a lower portion with a shaft interposed therebetween, it is possible to simplify the apparatus. Therefore, with the water-flow power generating apparatus relating to the present invention, in the water-flow power generating apparatus that generates electricity by the rotation force of one rotor, it is possible to maintain the attitude of the apparatus main body stably in the water while intending simplification of the apparatus.

Further, it is preferable that in the apparatus main body, the center of buoyancy is on a vertical upper side with respect to the center axis of the rotation shaft of the rotor. With this, a distance from the center of buoyancy to the center axis of the rotation shaft can be made large sufficiently. As a result, when the apparatus main body inclines in the acting direction of the reaction torque, the rotation torque that acts on the apparatus main body around the center axis of the rotation shaft serving as a center by the buoyancy, can be made larger more. Therefore, it becomes possible to make the inclination angle of the apparatus main body smaller.

Further, it is preferable that in the apparatus main body, the center of gravity is disposed on a vertical lower side with respect to the center axis of the rotation shaft of the rotor. With this, a distance from the center of gravity to the center axis of the rotation shaft can be made large sufficiently. As a result, when the apparatus main body inclines in the acting direction of the reaction torque, the rotation torque that acts on the apparatus main body around the center axis of the rotation shaft serving as a center by the gravity, can be made larger. Therefore, it becomes possible to make the inclination angle of the apparatus main body smaller.

Further, it is preferable that in the pod, an inner space on a vertical upper side with respect to the center axis of the rotation shaft of the rotor is wider than an inner space on a vertical lower side with respect to the center axis of the rotation shaft. With this, since the inner space on the vertical upper side with respect to the center axis of the rotation shaft in the pod can be made into a cavity being as wide as possible, it becomes possible to dispose easily the center of buoyancy of the apparatus main body on the vertical upper side with respect to the center axis of the rotation shaft of the rotor.

Further, it is preferable that the mooring cable includes a plurality of first mooring cables to be fixed to the bottom of water at respective positions separated from each other in a direction orthogonal to a water-flow direction among horizontal directions, and the connecting mechanism includes a first connecting mechanism for connecting the plurality of first mooring cables at a same position of the pod. With this, it is possible to suppress, by the first mooring cables, the apparatus main body from moving in the direction orthogonal to the direction of a water flow among the horizontal directions. Accordingly, it becomes possible to make the apparatus main body stay in the water stably. Moreover, by connecting the first mooring cables at the same position of the pod with the first connecting mechanism, when the apparatus main body inclines along the vertical plane orthogonal to the rotation shaft of the rotor, it is possible to make the apparatus main body rotate relative to the first mooring cables on the first connecting mechanism as a base point. As a result, since it is possible to suppress only some of the first mooring cables from deflecting or twisting, it becomes possible to maintain the attitude of the apparatus main body in the water stably.

Further, it is preferable that the mooring cable further includes a second mooring cable, the connecting mechanism includes a second connecting mechanism for connecting the second mooring cable to the pod on a side closer to the plurality of blades than to the first connecting mechanism, and the first connecting mechanism and the second connecting mechanism are disposed at respective positions that overlap with each other when viewed from an axial direction of the rotation shaft. With this, by the second mooring cable, it is possible to suppress the apparatus main body on the side closer to the blades from floating upward and to intend to stabilize more the attitude of the apparatus main body in the water. Moreover, by disposing the first connecting mechanism and the second connecting mechanism at the respective positions that overlap with each other when viewed from the axial direction of the rotation shaft, when the apparatus main body inclines along a vertical plane orthogonal to the center axis of the rotation shaft of the rotor, it is possible to make the apparatus main body move rotationally relative to the first mooring cables and the second mooring cable on the first connecting mechanism and the second connecting mechanism as a base point. As a result, since it is possible to suppress only some of the first mooring cables and the second mooring cable from deflecting or twisting, it becomes possible to maintain the attitude of the apparatus main body in the water stably.

Further, it is preferable that an auxiliary cable connected to the pod on a side opposite to the plurality of blades with respect to the second connecting mechanism and fixed to the second mooring cable is further included. With this, it is possible to suppress, by the auxiliary cable, the second mooring cable from deflecting toward the blades and interfering with the cables.

Further, it is preferable that a relative position between a connecting portion of the auxiliary cable and the pod and a fixing portion of the auxiliary cable and the second mooring cable is adjustable. With this, when having initially disposed the apparatus main body in the water, by adjusting the relative position between the connecting portion of the auxiliary cable and the pod and the fixing portion of the auxiliary cable and the second mooring cable, it is possible to adjust the initial attitude of the apparatus main body so as to become horizontal.

Further, it is preferable that the apparatus main body includes a plurality of wing portions that are attached to the pod to make rotation torque of the rotation direction of the rotor act on the apparatus main body by a force received from a water flow. With this, by the rotation torque that acts on the apparatus main body toward the rotation direction of the rotor, i.e., a direction opposite to the reaction torque, it is possible to prevent the apparatus main body from rotating due to the reaction torque. Therefore, with respect to the water-flow power generating apparatus that generates electricity by the rotation of a single rotor, it is possible to maintain the attitude of the apparatus main body stably in the water.

Further, it is preferable that the plurality of wing portions make a force in a vertically downward direction act on the apparatus main body. With this, by the force from the wing portions, it is possible to make the apparatus main body move to the vertical lower side and to locate promptly the apparatus main body at a position where it stays most stably in the water.

### Advantageous Effects of Invention

In the water-flow power generating apparatus that generates electricity by the rotation force of one rotor, the water-flow power generating apparatus relating to the present invention exerts an effect that it is possible to maintain the attitude of the apparatus main body stably in the water while intending simplification of the apparatus.

### BRIEF DESCRIPTION OF DRAWINGS

FIG. 1 is a schematic drawing illustrating a water-flow power generating apparatus according to a first embodiment.

FIG. 2 is a side view illustrating a pod.

FIG. 3 is a rear view illustrating the pod.

FIG. 4 is an enlarged view illustrating a connecting mechanism.

FIG. 5 is a schematic diagram for describing a principle needed for an apparatus main body of the water-flow power generating apparatus to maintain its attitude in the water.

FIG. 6 is an explanatory diagram illustrating an example of a supporting mechanism of an internal component to be accommodated in the pod.

FIG. 7 is an explanatory diagram illustrating another example of the supporting mechanism of the internal component to be accommodated in the pod.

FIG. 8 is a schematic drawing illustrating a water-flow power generating apparatus according to a second embodiment.

FIG. 9 is a left side view illustrating an apparatus main body of the water-flow power generating apparatus according to the second embodiment.

FIG. 10 is a front view illustrating an apparatus main body of the water-flow power generating apparatus according to the second embodiment.

FIG. 11 is a front view illustrating a state where the apparatus main body inclines in the water-flow power generating apparatus according to the second embodiment.

FIG. 12 is an explanatory drawing illustrating a constitution of a first connecting mechanism and a second connecting mechanism.

FIG. 13 is an explanatory drawing illustrating an example in which an initial attitude of the apparatus main body is adjusted by adjusting the length of an auxiliary cable.

FIG. 14 is an explanatory drawing illustrating an example in which the initial attitude of the apparatus main body is adjusted by adjusting the length of the auxiliary cable.

FIG. 15 is a schematic drawing illustrating a water-flow power generating apparatus according to a modified example of the second embodiment.

FIG. 16 is an explanatory drawing illustrating a pod according to a modified example.

FIG. 17 is an explanatory drawing illustrating a pod according to a modified example.

FIG. 18 is an explanatory drawing illustrating a pod according to a modified example.

FIG. 19 is a schematic drawing illustrating a water-flow power generating apparatus according to a third embodiment.

FIG. 20 is a schematic drawing of an apparatus main body of the water-flow power generating apparatus according to the third embodiment when viewed from its front side.

FIG. 21 is a sectional view illustrating a first wing portion.

FIG. 22 is a sectional view illustrating a second wing portion.

### DESCRIPTION OF EMBODIMENTS

Hereinafter, embodiments of a water-flow power generating apparatus according to the present invention will be described in detail on the basis of drawings. It should be noted that the invention should not be limited by these embodiments.

### First Embodiment

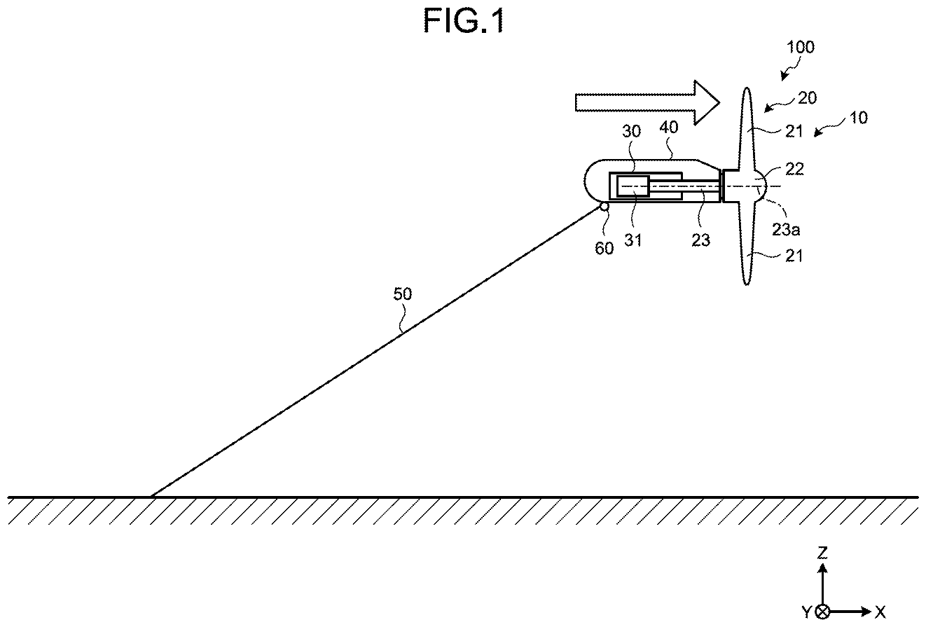

FIG. 1 is a schematic drawing illustrating a water-flow power generating apparatus according to the first embodiment. A water-flow power generating apparatus 100 is an underwater floating-type power generating apparatus that is disposed in the water and generates electricity with ocean current energy or tidal current energy. In this connection, the water-flow power generating apparatus 100 may be one that is disposed in a river and generates electricity with river current energy. As illustrated in FIG. 1, the water-flow power generating apparatus 100 includes a rotor 20 that rotates by a force that a plurality of blades 21 (two blades in the present embodiment) receive from a water flow (ocean current or tidal current), an internal component 30, an apparatus main body 10 that includes a pod 40 to accommodate the internal component 30, a mooring cable 50 that moors the apparatus main body 10 to a bottom of water (sea bottom), and a connecting mechanism 60 that connects the mooring cable 50 to the pod 40.

The rotor 20 of the apparatus main body 10 includes a rotor head 22 on the peripheral surface of which the blades 21 are attached at equal intervals and a rotation shaft 23 that extends from the rotor head 22 and is connected to a power generator 31. When a water flow being flowing in a direction indicated with a white arrow in FIG. 1 hits onto the blades 21, the rotor head 22 rotates around a center axis 23a of the rotation shaft 23 by water flow energy acting on the blades 21. In the following description, a direction parallel to the center axis 23a of the rotation shaft 23 is referred to as “axial direction”, and a direction orthogonal to the center axis 23a of the rotation shaft 23 is referred to as “radial direction”. Moreover, in the following description, an upstream side (a left side illustrated in FIG. 1) of a water flow direction is a front side of the apparatus main body 10, and a downstream side (a right side illustrated in FIG. 1) of the water flow direction is a back side of the apparatus main body 10.

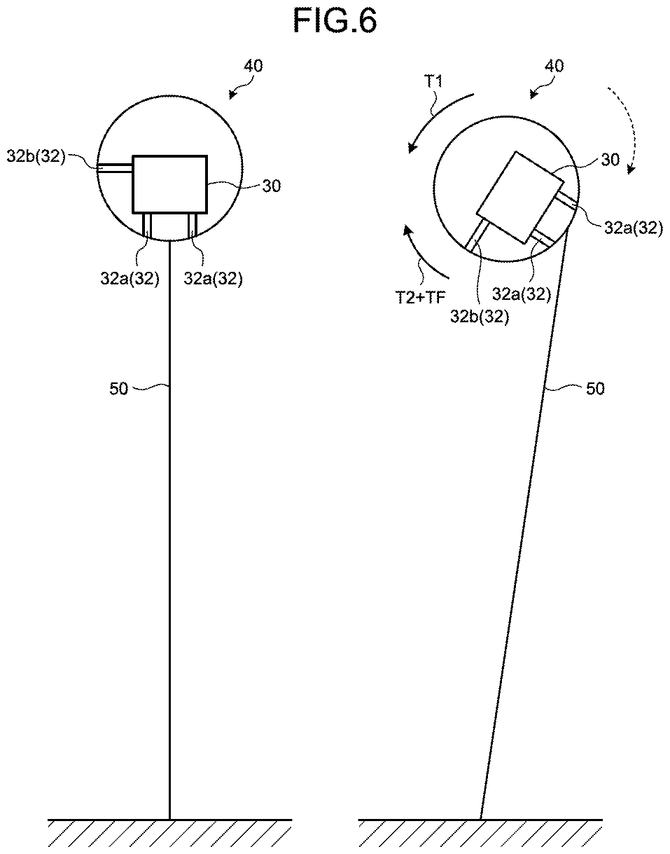

The internal component 30 includes the power generator 31 that generates electricity by the rotation force of the rotor 20. The internal component 30 may also include a non-illustrated drive train, etc. that connect the power generator 31 to the rotation shaft 23. The rotation energy (rotation torque) of the rotor 20 is transmitted to the power generator 31 from the rotation shaft 23, and the power generator 31 generates electricity. The electric power generated by the power generator 31 is sent to the ground through a non-illustrated power transmission cable. In the present embodiment, the internal component 30 including the power generator 31 is accommodated in a lower portion of an inner space of the pod 40 and is fixed to an internal surface of the pod 40 through a plurality of supporting members 32 (refer to FIG. 6).

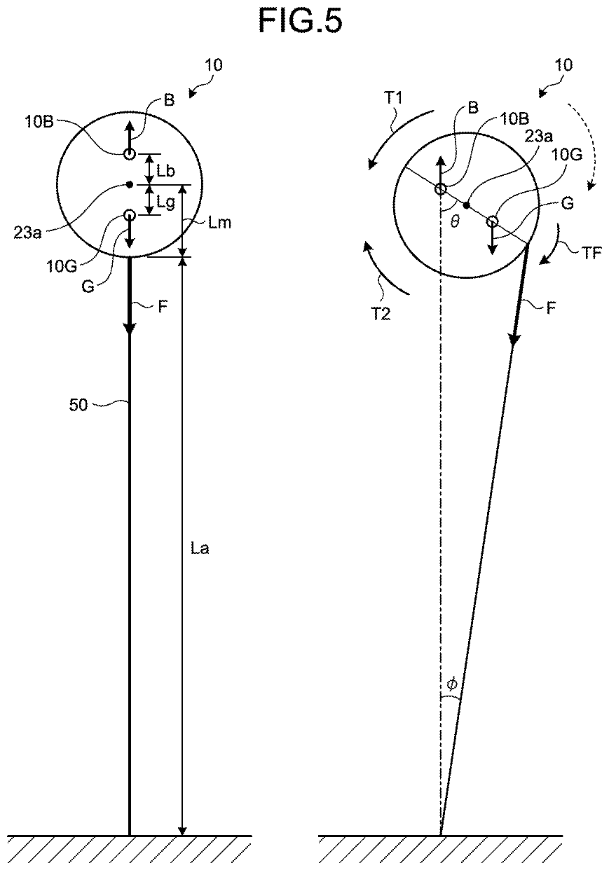

The pod 40 is a cylindrical member extending along the axial direction. An inner space of the pod 40 is filled with gas. With this, the pressure (inner pressure) of the inner space of the pod 40 is held. Moreover, by the gas filled in the inner space, buoyancy B (refer to FIG. 5) acting on the apparatus main body 10 is adjusted. In the water-flow power generating apparatus 100, the buoyancy B is set larger than gravity G (refer to FIG. 5) acting on the apparatus main body 10. A gas to be filled in the inner space of the pod 40 may be air or may be gas other than air. By selecting the kind of a gas, a pressure in the inner space of the pod 40 may be adjusted, or the buoyancy B acting on the apparatus main body 10 may be adjusted. For example, a gas having a low specific gravity and having a fire resistance may be used.

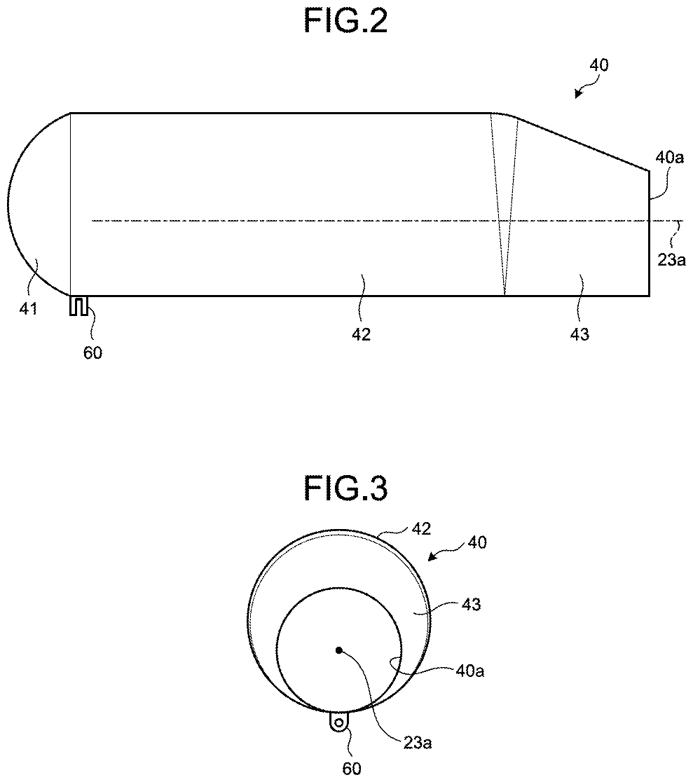

FIG. 2 is a side view illustrating the pod, and FIG. 3 is a rear view illustrating the pod. As illustrated in the drawings, the pod 40 includes a head portion 41, a large diameter portion 42 extending along the axial direction from the head portion 41, and a small diameter portion 43 extending from the large diameter portion 42 while reducing the diameter. The pod 40 includes an opening portion 40a at an end of the small diameter portion 43 on a side opposite to the head portion 41. The rotation shaft 23 of the rotor 20 is inserted in the inside of the pod 40 through this opening portion 40a. The center of the opening portion 40a coincides with the center axis 23a of the rotation shaft 23. The lower end of the small diameter portion 43 extends horizontally with the lower end of the large diameter portion 42. Moreover, on portions other than the lower end, the small diameter portion 43 exhibits a tapered shape in which an outside diameter gradually reduces from the large diameter portion 42 toward the opening portion 40a. In this connection, the large diameter portion 42 is shaped in a size to an extent not to disturb the flow of a water flow to the blades 21. Moreover, also by shaping the small diameter portion 43 into a tapered shape in which its outside diameter is reduced gradually toward the blades 21, it is possible not to disturb the flow of a water flow to the blades 21.

With the above-described constitution, in the pod 40, its center axis is located on a vertical upper side with respect to the center axis 23a of the rotation shaft 23 except the end surface on the opening portion 40a side of the small diameter portion 43. Therefore, in the pod 40, an inner space on a vertical upper side with respect to the center axis 23a of the rotation shaft 23 becomes wider than an inner space on a vertical lower side with respect to the center axis 23a of the rotation shaft 23.

As illustrated in FIG. 1, one end of the mooring cable 50 is connected to the pod 40 through the connecting mechanism 60. Moreover, the other end of the mooring cable 50 is fixed to the bottom of water. The mooring cable 50 prevents the apparatus main body 10 from floating up in the water surface direction by the buoyancy B or prevents the apparatus main body 10 from being flowed by a water flow. The apparatus main body 10 can float in the water freely in the X axial direction, Y axial direction, and Z axial direction illustrated in FIG. 1 within a range of the length of the mooring cable 50. As a result, as compared with a case where the apparatus main body 10 is fixed completely to the bottom of water, it is possible to reduce stress caused on the apparatus main body 10 by a force received from a water flow.

Here, generally, as a distance from the water surface to a position becomes longer, a flow velocity at the position becomes smaller. When the apparatus main body 10 has been initially disposed in the water and then has received a water flow, the apparatus main body 10 moves in the vertical direction until it reaches a position where it can stably stay in the water. Upon having reached a position where the apparatus main body 10 can stay stably in the water, the apparatus main body 10 stays at the position, as long as there is no large change in the water flow.

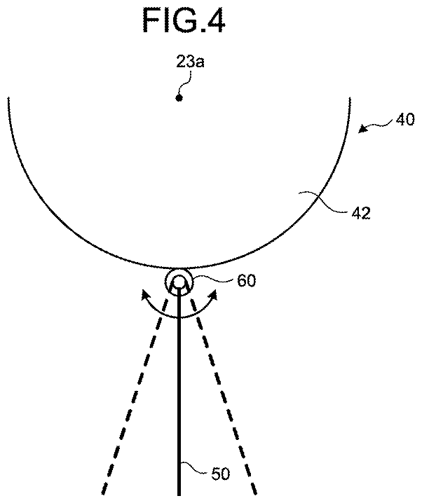

In the present embodiment, the connecting mechanism 60 is provided at a lower end on the head portion 41 side of the large diameter portion 42 of the pod 40. FIG. 4 is an enlarged view illustrating the connecting mechanism. As illustrated with a solid line arrow and a broken line in FIG. 4, the connecting mechanism 60 connects the mooring cable 50 and the pod 40 so as to be movable relatively to each other along a vertical plane orthogonal to the center axis 23a of the rotation shaft 23 of the rotor 20. With this, the apparatus main body 10 is allowed to incline along the vertical plane orthogonal to the center axis 23a of the rotation shaft 23 of the rotor 20. As a result, when the apparatus main body 10 inclines, on the connecting portion between the mooring cable 50 and the pod 40, only tensile stress arises, and stress due to a bending moment does not arise. Accordingly, it is possible to intend to reduce stress in the connecting portion. In this connection, “a vertical plane orthogonal to the center axis 23a” points to a YZ plane illustrated in FIG. 1 in the case where the center axis 23a of the rotation shaft 23 coincides with the X axial direction illustrated in FIG. 1.

FIG. 5 is a schematic drawing for describing a principle needed for the apparatus main body of the water-flow power generating apparatus to maintain its attitude in the water. A left figure in the drawing is a schematic drawing that views the water-flow power generating apparatus 100 having been initially disposed in the water from its front side, and a right figure in the drawing is a schematic drawing that views the water-flow power generating apparatus 100 when the rotor 20 is being rotated by a water flow from its front side. In this connection, in FIG. 5, in order to simplify the description, the description for each constitution component of the apparatus main body 10 is omitted, and the apparatus main body 10 is schematically illustrated with a circle form.

As mentioned in the above, in the present embodiment, the internal component 30 is disposed at the lower part of the pod 40. As a result, as illustrated in the left figure in FIG. 5, in the apparatus main body 10, center of gravity 10G is disposed on a vertical lower side with respect to the center axis 23a of the rotation shaft 23 of the rotor 20. Moreover, as mentioned in the above, in the pod 40, an inner space on a vertical upper side with respect to the center axis 23a of the rotation shaft 23 is wider than an inner space on a vertical lower side with respect to the center axis 23a of the rotation shaft 23. As a result, in the apparatus main body 10, as illustrated in the left figure in FIG. 5, center of buoyancy 10B is disposed on a vertical upper side with respect to the center axis 23a of rotation shaft 23 of the rotor 20. With this, it is possible to dispose the center of buoyancy 10B on a vertical upper side with respect to the center of gravity 10G, without attaching a float section and a ballast section to the pod 40 with a shaft interposed therebetween. In the present embodiment, the center of buoyancy 10B, the center of gravity 10G, and the center axis 23a of the rotation shaft 23 in the apparatus main body 10 are disposed on a straight line. The apparatus main body 10 receives the buoyancy B of the vertically upward direction at the center of buoyancy 10B and receives the gravity G of a vertically downward direction at the center of gravity 10G. Moreover, the apparatus main body 10 receives a force F of the vertically downward direction on the basis of the tension of the mooring cable 50. The “force F” herein points out a force in a Z axial direction (vertical direction) component in FIG. 1 among the whole tension which acts on the apparatus main body 10 from the mooring cable 50.

In the state illustrated in the left figure in FIG. 5, when the blades 21 receive a force from a water flow and then the rotor 20 rotates, the apparatus main body 10 receives reaction torque T1 in a direction opposite to the rotation direction of the rotor 20 indicated with a broken line arrow in the right figure in FIG. 5. As a result, as illustrated in the right figure in FIG. 5, the apparatus main body 10 inclines relative to the vertical direction along a vertical plane orthogonal to the center axis 23a. With this, the center of buoyancy 10B moves to the acting direction side of the reaction torque T1 on the vertical upper side with respect to the center axis 23a, and the center of gravity 10G moves to the acting direction side of the reaction torque T1 on the vertical lower side with respect to the center axis 23a.

As a result, by the buoyancy B at the center of buoyancy 10B and the gravity G at the center of gravity 10G, rotation torque T2 acts on the apparatus main body 10 in the rotation direction of the rotor 20, i.e., in the direction opposite to the reaction torque T1. Moreover, also by the force F of the vertically downward direction on the basis of the tension of the mooring cable 50, the apparatus main body 10 receives rotation torque TF in the direction opposite to the reaction torque T1. In the case where the resultant force of the rotation torque T2 and the rotation torque TF balances with the reaction torque T1, the attitude of the apparatus main body 10 is maintained in the water. Thereby, it is possible to suppress situations that the apparatus main body 10 rotates in the water by the reaction torque T1 and inclines with an inclination angle θ of a predetermined angle (for example, 90 degrees) or more relative to the vertical direction, and that the apparatus main body 10 becomes unable to stay in a water flow stably.

Here, description will be given for an example of the inclination angle θ in a state where the attitude of the apparatus main body 10 is maintained in the water. As illustrated in the left figure in FIG. 5, it is assumed that a distance from the center axis 23a of the rotation shaft 23 to the center of buoyancy 10B is “Lb” and a distance from the center axis 23a of the rotation shaft 23 to the center of gravity 10G is “Lg”. Moreover, it is assumed that a distance from the center axis 23a of the rotation shaft 23 to a position where the mooring cable 50 is connected to the apparatus main body 10 is “Lm” and a distance from the apparatus main body 10 to a position where the mooring cable 50 is fixed to the bottom of water is “La”. Furthermore, as illustrated in the right figure in FIG. 5, an inclination angle of the mooring cable 50 relative to the vertical direction is “φ”. Now, in the case where it is assumed that the attitude of the apparatus main body 10 is maintained in the water at a position where the center of buoyancy 10B and the mooring point of the mooring cable 50 to the bottom of water are aligned in the vertical direction as illustrated in the right figure of FIG. 5, Equation (1) is established. Moreover, Equation (2) is established from the balance among the forces in the vertical direction that act on the apparatus main body 10. Moreover, Equation (3) is established from the balance of forces between the rotation torque T2 by the buoyancy B and the gravity G and the rotation torque TF by the force F based on the tension from the mooring cable 50 and the reaction torque T1. On the basis of from Equation (1) to Equation (3), by setting appropriately the value of each of “Lb”, “Lm”, “La”, “B”, “G”, and “T1”, it is possible to set an inclination angle θ of the apparatus main body 10 relative to the vertical direction within a predetermined range.

(Lb+Lm)*sin θ=La*Sin φ (1)

B=G+F cos φ (2)

T1=T2+TF=B*Lb*sin θ+G*Lg*sin θ+F*Lm*cos(π/2−φ−θ) (3)

Even in the case where the apparatus main body 10 is inclined at the inclination angle θ that is within a predetermined range, if each part is designed and supported in the pod 40 so as not to influence the functional maintenance of the internal component 30 accommodated in the pod 40, such as the power generator 31 and the non-illustrated drive train, the power generation function by the water-flow power generating apparatus 100 will not be spoiled. FIG. 6 is an explanatory diagram illustrating an example of a supporting mechanism of the internal component accommodated in the pod. A left figure in the diagram is a schematic diagram in which the water-flow power generating apparatus 100 having been initially disposed in the water is viewed from its front side, and a right figure in the diagram is a schematic diagram in which the water-flow power generating apparatus 100 when the rotor 20 is being rotated by a water flow is viewed from its front side. In this connection, in FIG. 6, in order to simplify description, the descriptions for constitutional elements other than the internal component 30 of the water-flow power generating apparatus 100, the supporting members 32, the pod 40, and the mooring cable 50, are omitted.

As illustrated in the drawings, in the present embodiment, the internal component 30 is fixed to a lower surface of the pod 40 through a plurality of first supporting members 32a attached to the lower surface. Moreover, the internal component 30 is fixed to a side surface of the pod 40 through a second supporting member 32b attached to the side surface. The second supporting member 32b is attached to the side surface that moves to a vertical lower side when the apparatus main body 10 of the internal component 30 inclines due to the reaction torque T1. With this, as illustrated in the right figure in FIG. 6, even in the case where the apparatus main body 10 inclines relative to the vertical direction due to the reaction torque T1, it is possible to support the internal component 30 stably by the second supporting member 32b.

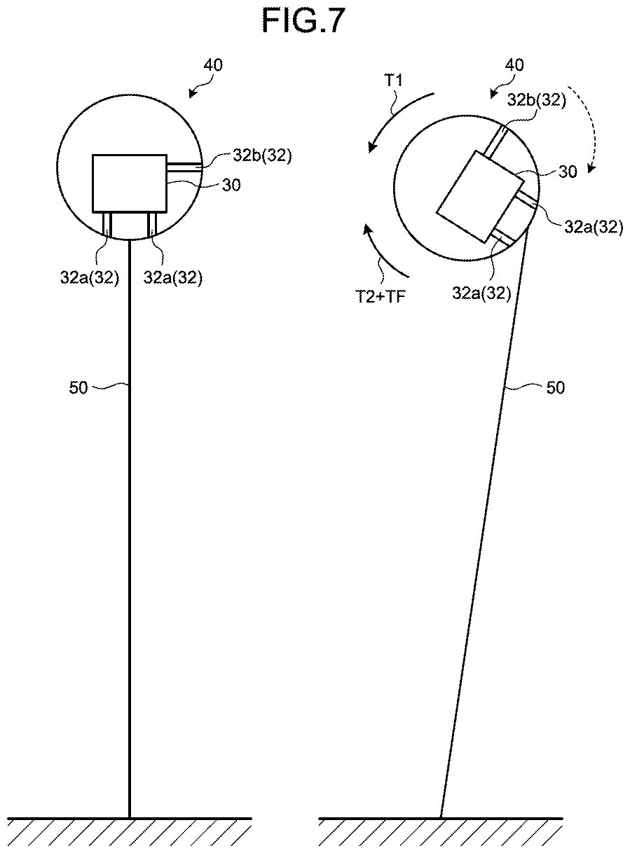

However, the attaching position of the second supporting member 32b is not limited to an example illustrated in FIG. 6. FIG. 7 is a diagram illustrating another example of the supporting mechanism of the internal component accommodated in the pod. As illustrated in the diagram, the second supporting member 32b may be attached to a side surface that moves to a vertical upper side when the apparatus main body 10 of the internal components 30 inclines due to the reaction torque T1. Even in this case, as long as the second supporting member 32b can be firmly fixed to the side surface of the internal component 30 and the inner peripheral surface of the pod 40, even if the apparatus main body 10 inclines relative to the vertical direction due to the reaction torque T1, it is possible to support the internal component 30 stably.

As having described in the above, in the water-flow power generating apparatus 100 according to the first embodiment, by the connecting mechanism 60, the mooring cable 50 to moor the apparatus main body 10 to the bottom of water and the pod 40 are connected so as to be movable relatively to each other along a vertical plane orthogonal to the center axis 23a of the rotation shaft 23 of the rotor, whereby the inclination of the apparatus main body 10 along this vertical plane is permitted. Moreover, in the water-flow power generating apparatus 100 according to the first embodiment, the center of buoyancy 10B of the apparatus main body 10 is disposed on a vertical upper side with respect to the center of gravity 10G, and when the apparatus main body 10 inclines, by the rotation torque T2 that acts on the apparatus main body 10 in the rotational direction of the rotor 20, i.e., in the direction opposite to the reaction torque T1 by the buoyancy B at the center of buoyancy 10B and the gravity G at the center of gravity 10G, it is possible to prevent the apparatus main body 10 from rotating due to the reaction torque T1. As a result, as compared with a constitution to dispose a float section on the upper part of the apparatus main body 10 and a ballast section on the lower portion with a shaft interposed therebetween, it is possible to simplify the apparatus. Therefore, with the water-flow power generating apparatus 100 relating to the first embodiment, in the water-flow power generating apparatus 100 that generates electricity by the rotation force of one rotor 20, it is possible to maintain the attitude of the apparatus main body 10 stably in the water while intending simplification of the apparatus.

In this way, with the water-flow power generating apparatus 100 that generates electricity by the rotation of the one rotor 20, as compared with a constitution that cancels the reaction torque T1 acting on the entire apparatus by connecting, with a structure body, two or more apparatus main bodies 10 each including blades and a rotor that rotate oppositely to each other, it is possible to simplify the apparatus constitution. Moreover, in the case where the two or more apparatus main bodies 10 are connected to the structure body, stress occurs intensively at the connecting portion. However, with the water-flow power generating apparatus 100, a stress concentration portion does not occur, whereby it is possible to improve the durability of the whole apparatus. Furthermore, with the water-flow power generating apparatus 100, the structure body that connects the apparatus main body 10 does not generate the disturbance of a water flow. Therefore, the power generation efficiency by the power generator 31 can be improved, and it is possible to suppress a situation that large stress occurs locally on the apparatus main body 10 due to disturbance of a water flow. Moreover, in the constitution that cancels the reaction torque T1 acting on the entire apparatus by connecting two or more apparatus main bodies 10 with a structure body, in the case where troubles occur on a power generator, etc. included in one of the apparatus main bodies 10, unless the operation of the other one of the apparatus main bodies 10 is also stopped, the attitude of the whole apparatus cannot be maintained in the water. In the water-flow power generating apparatus 100 according to the present embodiment, regardless of the trouble situation of the other apparatus main body 10 (other water-flow power generating apparatus 100), the operation can be performed continuously. Accordingly, power generation can be performed stably. Furthermore, in the case of manufacturing a plurality of water-flow power generating apparatuses 100, by determining the rotation direction of the rotor 20 to one direction, the types of parts can be halved. Accordingly, it is possible to reduce the manufacturing cost and maintenance cost of the apparatus.

Moreover, in the apparatus main body 10, the center of buoyancy 10B is disposed on a vertical upper side with respect to the center axis 23a of the rotation shaft 23 of the rotor 20. With this, the distance Lb from the center of buoyancy 10B to the center axis 23a of the rotation shaft 23 can be made large sufficiently. As a result, when the apparatus main body 10 inclines in the acting direction of the reaction torque T1, the rotation torque T2 that acts on the apparatus main body 10 around the center axis 23a of the rotation shaft 23 serving as a center by the buoyancy B, can be made larger. Therefore, it becomes possible to make the inclination angle θ of the apparatus main body 10 smaller.

Moreover, in the apparatus main body 10, the center of gravity 10G is disposed on a vertical lower side with respect to the center axis 23a of the rotation shaft 23 of the rotor 20. With this, the distance Lg from the center of gravity 10G to the center axis 23a of the rotation shaft 23 can be made large sufficiently. As a result, when the apparatus main body 10 inclines in the acting direction of the reaction torque T1, the rotation torque T2 that acts on the apparatus main body 10 around the center axis 23a of the rotation shaft 23 serving as a center by the gravity G, can be made larger. Therefore, it becomes possible to make the inclination angle θ of the apparatus main body 10 smaller.

Moreover, in the pod 40, an inner space on a vertical upper side with respect to the center axis 23a of rotation shaft 23 of the rotor 20 is wider than an inner space on a vertical lower side with respect to the center axis 23a of rotation shaft 23. With this, since the inner space on the vertical upper side with respect to the center axis 23a of the rotation shaft 23 in the pod 40 can be made into a cavity as wide as possible, it becomes possible to dispose easily the center of buoyancy 10B of the apparatus main body 10 on a vertical upper side with respect to the center axis 23a of the rotation shaft 23 of the rotor 20.

In this connection, when the apparatus main body 10 inclines in the acting direction of the reaction torque T1 by the action of the reaction torque T1, as long as the resultant force of the rotation torque T2 and the rotation torque TF balances with the reaction torque T1 such that the attitude of the apparatus main body 10 can be maintained, the connecting mechanism 60 may be disposed at any position of the pod 40.

### Second Embodiment

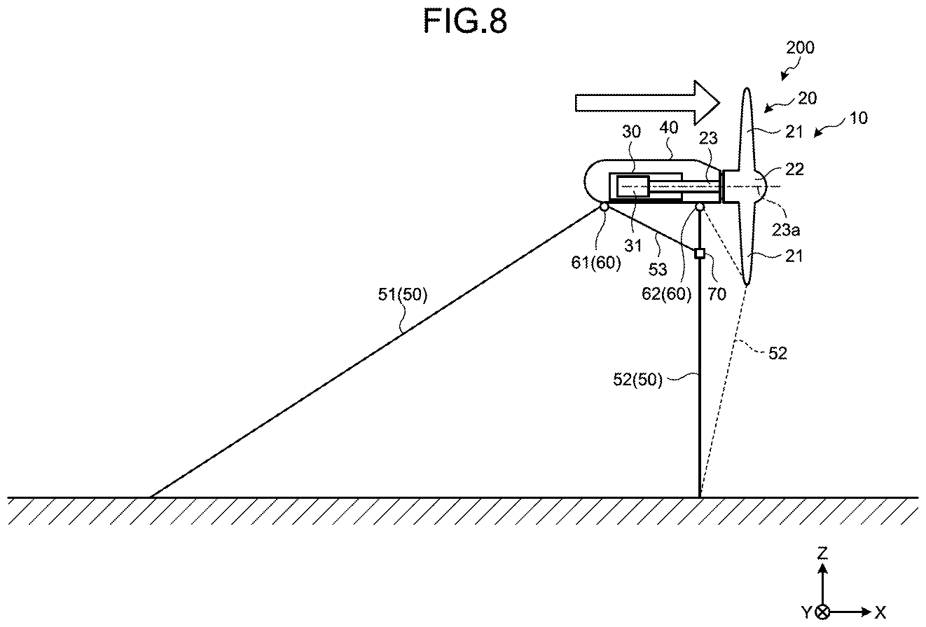

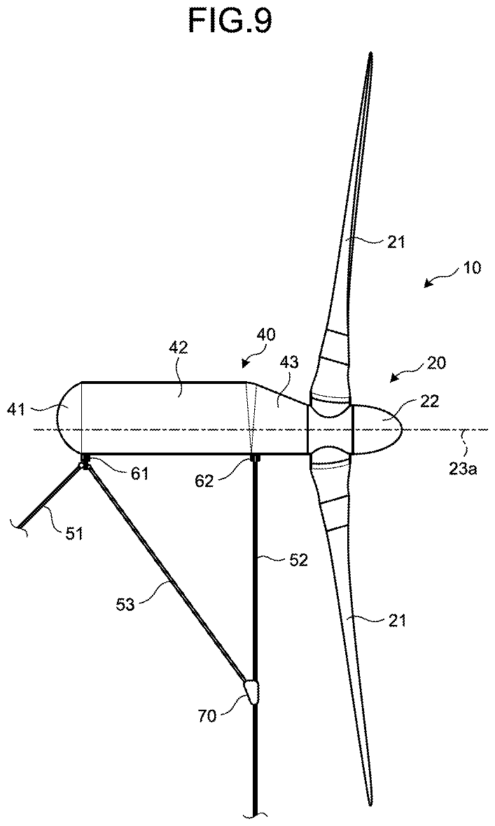

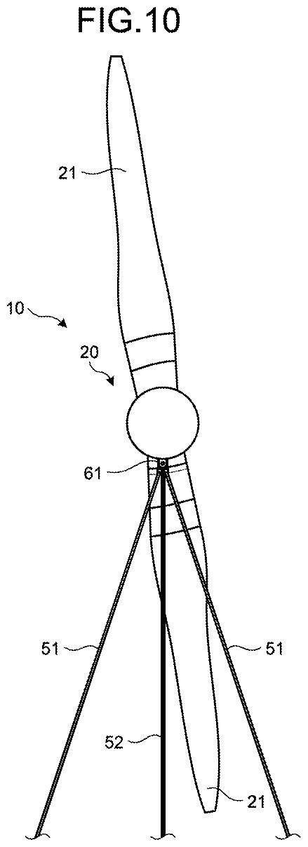

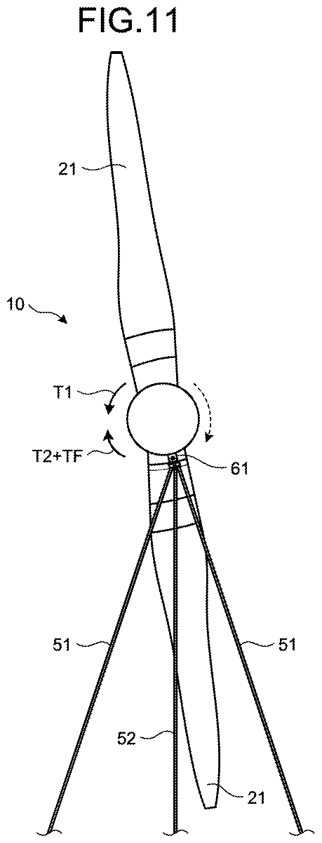

Next, a water-flow power generating apparatus 200 according to the second embodiment will be described. FIG. 8 is a schematic drawing illustrating a water-flow power generating apparatus according to the second embodiment, FIG. 9 is a left side view illustrating an apparatus main body of the water-flow power generating apparatus according to the second embodiment, FIG. 10 is a front view illustrating the apparatus main body of the water-flow power generating apparatus according to the second embodiment, and FIG. 11 is a front view illustrating a state where the apparatus main body inclines in the water-flow power generating apparatus according to the second embodiment.

In the water-flow power generating apparatus 200, as illustrated from FIG. 8 to FIG. 10, the mooring cable 50 includes a plurality of first mooring cables 51 and one second mooring cable 52. Moreover, in the water-flow power generating apparatus 200, the connecting mechanism 60 includes a first connecting mechanism 61 and a second connecting mechanism 62. Moreover, the water-flow power generating apparatus 200 includes an auxiliary cable 53. Since the other constitutions of the water-flow power generating apparatus 200 are similar to those of the water-flow power generating apparatus 100, description for them is omitted.

The two first mooring cables 51 have the same length. One end of each of the two first mooring cables 51 is connected to the pod 40 at the same position through the first connecting mechanism 61. In the present embodiment, as illustrated in FIG. 8, the first connecting mechanism 61 is disposed near an end of the pod 40 on a side opposite to the blades 21. Moreover, the other end of each of the two first mooring cables 51 is fixed to the bottom of water. As illustrated in FIG. 10, as the two first mooring cables 51 proceeds from a position where the they are connected to the pod 40 by the first connecting mechanism 61, toward the bottom of water, the two first mooring cables 51 extend in the respective directions so as to be separated from each other. As a result, the two first mooring cables 51 are fixed to the bottom of water at the respective positions separated from each other in a direction (Y axial direction illustrated in FIG. 8) orthogonal to the direction of a water flow among horizontal directions. Among the horizontal directions, the two first mooring cables 51 suppress the movement of the apparatus main body 10 in the direction (Y axial direction illustrated in FIG. 8) orthogonal to the direction of a water flow.

As illustrated in FIG. 8, one end of the second mooring cable 52 is connected to the pod 40 through the second connecting mechanism 62. In the present embodiment, as illustrated in FIG. 8, the second connecting mechanism 62 is disposed on the pod 40 on the side closer to the blades 21 than to the first connecting mechanism 61. Moreover, the other end of the second mooring cable 52 is fixed to the bottom of water. At a time point when the water-flow power generating apparatus 200 has been initially disposed in the water, the second mooring cable 52 extends along the vertical direction. The second mooring cable 52 suppresses the apparatus main body 10 on the side closer to the blades 21 from floating up as compared with the opposite side.

With this, in the water-flow power generating apparatus 200, the apparatus main body 10 can float around freely in the X axial direction and the Z axial direction illustrated in FIG. 8 within a range of the length of each of the two first mooring cables 51 and the second mooring cable 52. Moreover, also in the water-flow power generating apparatus 200, when the apparatus main body 10 has been initially disposed in the water and then has received a water flow, the apparatus main body 10 moves in the vertical direction until it reaches a position where it can stably stay in the water. Upon having reached a position where the apparatus main body 10 can stay stably in the water, the apparatus main body 10 stays at the position, as long as there is no large change in the water flow.

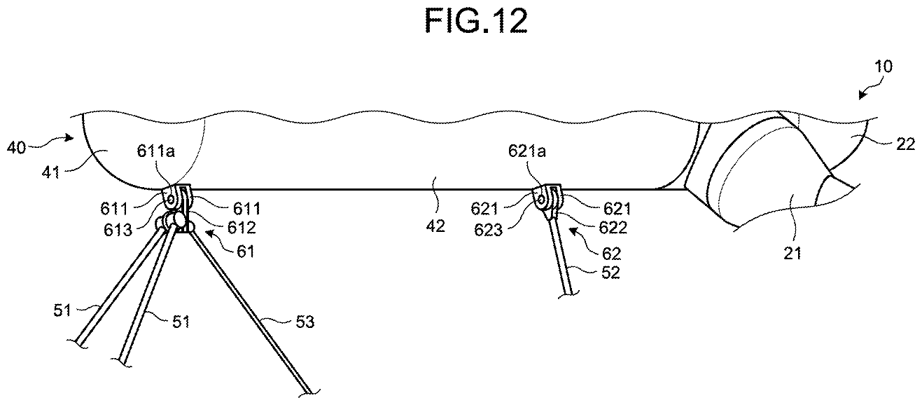

FIG. 12 is an explanatory drawing illustrating a constitution of the first connecting mechanism and the second connecting mechanism. The first connecting mechanism 61 is disposed at the lower end on the head portion 41 side of the large diameter portion 42 of the pod 40. As illustrated in FIG. 12, the first connecting mechanism 61 includes a pair of protruding portions 611 that protrude from the lower end portion of the pod 40 in the radial direction and a flat plate portion 612 that is pin-jointed to the pair of protruding portions 611 and to which the two first mooring cables 51 are attached. The pair of protruding portions 611 are formed at the respective positions separated from each other along the axial direction. Moreover, the pair of protruding portions 611 have through holes 611a extending along an axial direction. The flat plate portion 612 is sandwiched between the pair of protruding portions 611. Moreover, the flat plate portion 612 has a non-illustrated through hole extending along the axial direction. The pair of protruding portions 611 and the flat plate portion 612 are pin-jointed with a pin 613 that is inserted movably into the through holes 611a of the pair of protruding portions 611 and the non-illustrated through hole of the flat plate portion 612. With this, the two first mooring cables 51 are connected to the pod 40 at the same position. Moreover, the two first mooring cables 51 and the pod 40 are connected to be relatively movable along a vertical plane orthogonal to the center axis 23a of the rotation shaft 23 of the rotor 20. As a result, as illustrated in FIG. 11, the apparatus main body 10 becomes rotatable on the first connecting mechanism 61 as a base point relative to the two first mooring cables 51.

The second connecting mechanism 62 is disposed at the lower end of the large diameter portion 42 of the pod 40. The second connecting mechanism 62 is formed at a position at which it overlaps with the first connecting mechanism 61 when viewed from the axial direction. As illustrated in FIG. 12, the second connecting mechanism 62 includes a pair of protruding portions 621 that protrude from the lower end portion of the pod 40 in the radial direction and a flat plate portion 622 that is pin-joined to the pair of protruding portions 621 and to which the second mooring cable 52 is attached. The pair of protruding portions 621 are formed at the respective positions separated from each other along the axial direction. Moreover, the pair of protruding portions 621 have through holes 621a extending along the axial direction. The flat plate portion 622 is sandwiched between the pair of protruding portions 621. Moreover, the flat plate portion 622 has a non-illustrated through hole extending along the axial direction. The pair of protruding portions 621 and the flat plate portion 622 are pin-jointed with a pin 623 that is inserted movably into the through holes 621a of the pair of protruding portions 621 and the non-illustrated through hole of the flat plate portion 622. With this, the second mooring cable 52 and the pod 40 are connected so as to be relatively movable along a vertical plane orthogonal to the center axis 23a of the rotation shaft 23 of the rotor 20. As a result, as illustrated in FIG. 11, the apparatus main body 10 becomes rotatable on the first connecting mechanism 61 and the second connecting mechanism 62 (in FIG. 11, illustration is omitted) as a base point relative to the two first mooring cables 51 and the second mooring cable 52.

As illustrated in FIG. 12, one end of the auxiliary cable 53 is attached to the flat plate portion 612 of the first connecting mechanism 61. That is, as illustrated in FIG. 8, one end of the auxiliary cable 53 is connected to the pod 40 on a side opposite to the blades 21 with respect to the second connecting mechanism 62. Moreover, as illustrated in FIG. 8, the other end of the auxiliary cable 53 is fixed to the middle of the second mooring cable 52 in a fixing portion 70. As indicated with a broken line in FIG. 8, the auxiliary cable 53 suppresses the second mooring cable 52 from deflecting toward the blades 21.

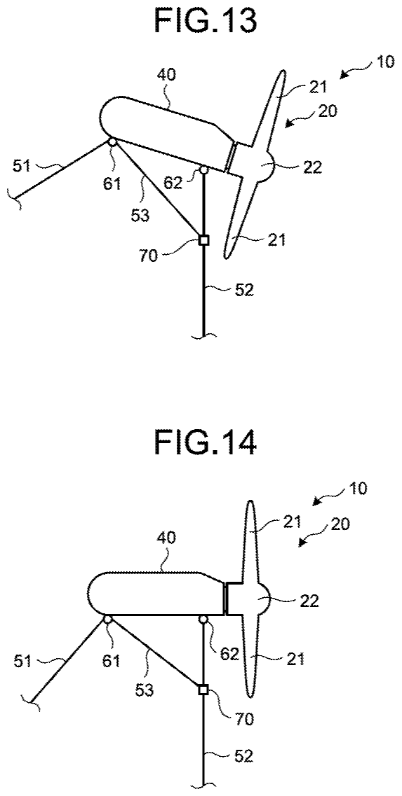

Moreover, in the present embodiment, the length of the auxiliary cable 53 is made adjustable between the first connecting mechanism 61 and the fixing portion 70 of the second mooring cable 52. FIG. 13 and FIG. 14 are explanatory drawings each illustrating an example in which the initial attitude of the apparatus main body is adjusted by adjusting the length of the auxiliary cable. For example, as illustrated in FIG. 13, when the apparatus main body 10 has been disposed initially in the water, in the case where the apparatus main body 10 on the side opposite to the blades 21 has floated upward more than expected, the length of the auxiliary cable 53 is made shorter as illustrated in FIG. 14. That is, the connecting portion of the auxiliary cable 53 and the pod 40 is brought closer to the fixing portion 70 of the auxiliary cable 53 and the second mooring cable 52. As a result, by the auxiliary cable 53, the apparatus main body 10 on the side opposite to the blades 21 is moved to the vertical lower side. Thereby, the initial attitude of the apparatus main body 10 can be adjusted to become horizontal. If the apparatus main body 10 has been disposed initially in the water, in the case where the apparatus main body 10 on the side closer to the blades 21 has floated upward more than expected, the length of the auxiliary cable 53 is made longer. That is, the connecting portion of the auxiliary cable 53 and the pod 40 is brought away relative to the fixing portion 70 of the auxiliary cable 53 and the second mooring cable 52. As a result, the apparatus main body 10 on the side opposite to the blades 21 is made to move to a vertical upper side, whereby the initial attitude of the apparatus main body 10 can be adjusted to become horizontal.

Also, in the water-flow power generating apparatus 200, when the blades 21 receive a force from a water flow and the rotor 20 rotates, as illustrated in FIG. 11, the reaction torque T1 acts on the apparatus main body 10, and then the apparatus main body 10 inclines relative to the vertical direction. As a result, similarly to the water-flow power generating apparatus 100 of the first embodiment, by the buoyancy B at the center of buoyancy 10B and the gravity G at the center of gravity 10G (illustration of each of them is omitted), the rotation torque T2 in the direction same as the rotation direction of the rotor 20, i.e., in the direction opposite to the reaction torque T1, acts on the apparatus main body 10. Thereby, in the case where the resultant force of the rotation torque T2 and the rotation torque TF by a force based on the tension of each of the two first mooring cables 51 and the second mooring cable 52 balances with the reaction torque T1, the attitude of the apparatus main body 10 is maintained in the water. Therefore, also in the water-flow power generating apparatus 200 according to the second embodiment, similarly to the water-flow power generating apparatus 100 according to the first embodiment, power generation can be performed by the rotation of a single rotor 20.

Moreover, by the first connecting mechanism 61, the two first mooring cables 51 and the pod 40 are connected so as to be relatively movable along a vertical plane orthogonal to the center axis 23a of the rotation shaft 23 of the rotor 20, and by the second connecting mechanism 62, the second mooring cable 52 and the pod 40 are connected so as to be relatively movable along a vertical plane orthogonal to the center axis 23a of the rotation shaft 23 of the rotor 20. With this, it is permitted that the apparatus main body 10 inclines along a vertical plane orthogonal to the center axis 23a of the rotation shaft 23 of the rotor 20. As a result, when the apparatus main body 10 inclines, only tensile stress arises in the connecting portion between each of the two first mooring cables 51 and the second mooring cable 52 and the pod 40 and the stress due to a bending moment does not arise, whereby it is possible to intend to reduce stress in the connecting portion. Therefore, with the water-flow power generating apparatus 200 according to the second embodiment, similarly to the water-flow power generating apparatus 100 according to the first embodiment, it is possible to favorably suppress damage of the connecting portion of the mooring cable 50 to moor the apparatus main body 10 to the bottom of water and the apparatus main body 10.

As having described in the above, in the water-flow power generating apparatus 200 according to the second embodiment, the mooring cable 50 includes the first mooring cables 51 to be fixed to the bottom of water at respective positions separated from each other in the direction orthogonal to the direction of a water current among horizontal directions, and the connecting mechanism 60 includes the first connecting mechanism 61 that connects the first mooring cables 51 at the same position of the pod 40. With this, it is possible to suppress, by the first mooring cables 51, the apparatus main body 10 from moving in the direction (Y axial direction illustrated in FIG. 8) orthogonal to the direction of a water flow among horizontal directions. Accordingly, it becomes possible to make the apparatus main body 10 stay in the water stably. Moreover, by connecting the first mooring cables 51 at the same position of the pod 40 with the first connecting mechanism 61, when the apparatus main body 10 inclines along a vertical plane orthogonal to the center axis 23a of the rotation shaft 23 of the rotor 20, it is possible to make the apparatus main body 10 rotate relative to the first mooring cables 51 on the first connecting mechanism 61 as a base point. As a result, since it is possible to suppress only some of the first mooring cables 51 from deflecting or twisting, it becomes possible to maintain the attitude of the apparatus main body 10 in the water stably.

Moreover, the mooring cable 50 further includes the second mooring cable 52, the connecting mechanism 60 includes the second connecting mechanism 62 that connects the second mooring cable 52 to the pod 40 on the side closer to the blades 21 than the first connecting mechanism 61, and the first connecting mechanism 61 and the second connecting mechanism 62 are disposed at respective positions that overlap with each other when viewed from the axial direction of the rotation shaft 23. With this, it is possible to suppress, by the second mooring cable 52, the apparatus main body 10 on the side closer to the blades 21 from floating upward and to intend to stabilize more the attitude of the apparatus main body 10 in the water. Moreover, by disposing the first connecting mechanism 61 and the second connecting mechanism 62 at respective positions that overlap with each other when viewed from the axial direction of the rotation shaft 23, when the apparatus main body 10 inclines along a vertical plane orthogonal to the center axis 23a of the rotation shaft 23 of the rotor 20, it is possible to make the apparatus main body 10 move rotationally on the first connecting mechanism 61 and the second connecting mechanism 62 as a base point relative to the first mooring cables 51 and the second mooring cable 52. As a result, since it is possible to suppress only some of the first mooring cables 51 and the second mooring cable 52 from deflecting or twisting, it becomes possible to maintain the attitude of the apparatus main body 10 in the water stably.

Moreover, there is further provided the auxiliary cable 53 that is connected to the pod 40 on a side opposite to the blades 21 with respect to the second connecting mechanism 62 and is fixed to the second mooring cable 52. With this, it is possible to suppress, by the auxiliary cable 53, the second mooring cable 52 from deflecting toward the blades 21. As a result, in the case where the flow velocity of a water flow is higher than expected, as indicated with a broken line in FIG. 8, it becomes possible to suppress the second mooring cable 52 from deflecting toward the blades 21 and interfering with the blades 21.

Moreover, a distance between the connecting portion of the auxiliary cable 53 and the pod 40 and the fixing portion 70 of the auxiliary cable 53 and the second mooring cable 52 can be adjusted. With this, when the apparatus main body 10 has been initially disposed in the water, by adjusting the distance between the connecting portion of the auxiliary cable 53 and the pod 40 and the fixing portion 70 of the auxiliary cable 53 and the second mooring cable 52, it is possible to adjust the initial attitude of the apparatus main body 10 so as to be horizontal.

In this connection, in the second embodiment, although it has been assumed that the two first mooring cables 51 are used, three or more first mooring cables 51 may be used. Moreover, in the second embodiment, although it has been assumed that one second mooring cable 52 is used, two or more second mooring cables 52 may be used. Moreover, the second mooring cable 52 and the second connecting mechanism 62 may be omitted from the water-flow power generating apparatus 200. Moreover, the auxiliary cable 53 may be omitted from the water-flow power generating apparatus 200.

Moreover, in the second embodiment, it has been assumed that the initial attitude of the apparatus main body 10 in the water is adjusted to be horizontal by adjusting the length of the auxiliary cable 53 between the first connecting mechanism 61 and the fixing portion 70 of the second mooring cable 52. However, a method of adjusting the initial attitude of the apparatus main body 10 in the water to be horizontal is not limited to this. For example, the auxiliary cable 53 has been connected to the pod 40 at a connecting portion different from the first connecting mechanism 61 in advance, and then, this connecting portion may be made movable in the axial direction. In this case, in the case where the apparatus main body 10 on the side opposite to the blades 21 floats upward more than expected, the connecting portion of the auxiliary cable 53 and the pod 40 is made to move toward a side opposite to the blades 21. That is, the connecting portion of the auxiliary cable 53 and the pod 40 is brought away in the axial direction from the fixing portion 70 of the auxiliary cable 53 and the second mooring cable 52. As a result, by moving the apparatus main body 10 on the side opposite to the blades 21 to the vertical lower side, it is possible to adjust the initial attitude of the apparatus main body 10 to be horizontal. Moreover, in the case where the apparatus main body 10 on the side closer to the blades 21 floats upward more than expected, the connecting portion of the auxiliary cable 53 and the pod 40 is moved toward the blades 21. That is, the connecting portion of the auxiliary cable 53 and the pod 40 is brought closer in the axial direction from the fixing portion 70 of the auxiliary cable 53 and the second mooring cable 52. As a result, by moving the apparatus main body 10 on the side opposite to the blades 21 to the vertical upper side, it is possible to adjust the initial attitude of the apparatus main body 10 to be horizontal.

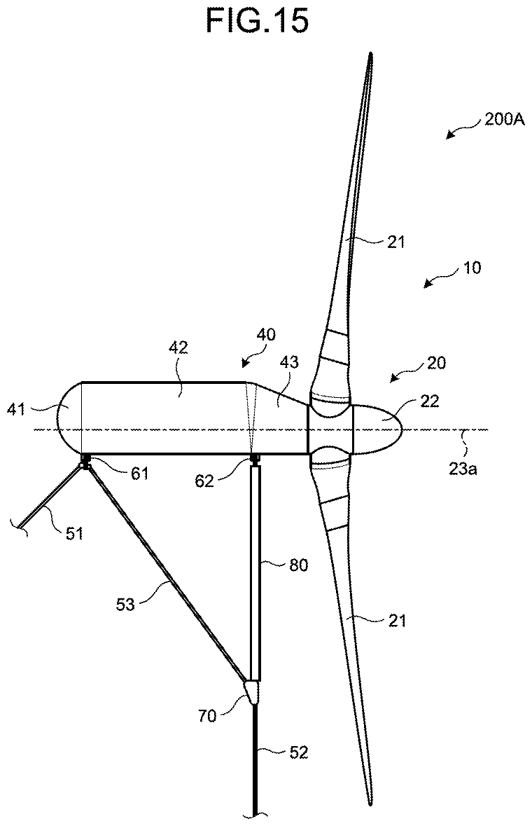

FIG. 15 is a schematic drawing illustrating a water-flow power generating apparatus according to a modified example of the second embodiment. As illustrated in the drawing, a water-flow power generating apparatus 200A according to the modified example includes a rod-like member 80 connected between the fixing portion 70 of the auxiliary cable 53 and the second mooring cable 52 and the second connecting mechanism 62. Since the other constitutions of the water-flow power generating apparatus 200A are the same as those of the water-flow power generating apparatus 200, the description for them is omitted. The rod-like member 80 is formed with, for example, relatively hard materials, such as metal. Moreover, the rod-like member 80 is connected to the pod 40 by the second connecting mechanism 62 so as to be movable around the center axis 23a of the rotation shaft 23. In this way, by connecting the relatively hard rod-like member 80 between the fixing portion 70 of the auxiliary cable 53 and the second mooring cable 52 and the second connecting mechanism 62, it is possible to more favorably suppress the second mooring cable 52 from deflecting toward the blades 21 and interfering with the blades 21.

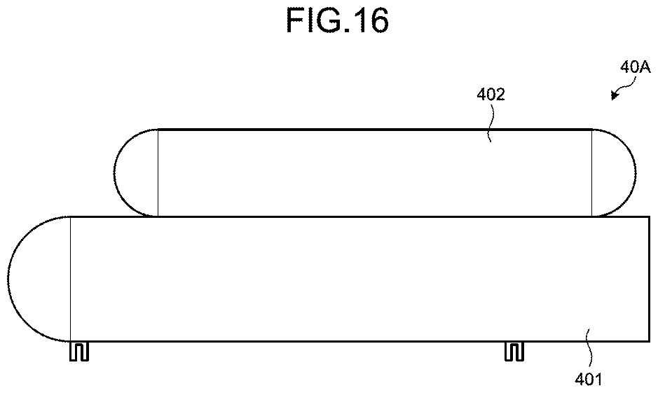

In the water-flow power generating apparatus 100 according to the first embodiment and the water-flow power generating apparatus 200 according to the second embodiment, it has been assumed that by making an inner space of the pod 40 on the vertical upper side with respect to the center axis 23a of the rotation shaft 23 wider than an inner space on the vertical lower side with respect to the center axis 23a of the rotation shaft 23, the center of buoyancy 10B of the apparatus main body 10 is disposed on a vertical upper side with respect to the center axis 23a of the rotation shaft 23. However, the method of disposing the center of buoyancy 10B of the apparatus main body 10 on a vertical upper side with respect to the center axis 23a of the rotation shaft 23 is not limited to this. Hereinafter, while referring to the drawings, description is given for other method of disposing the center of buoyancy 10B of the apparatus main body 10 on a vertical upper side with respect to the center axis 23a of the rotation shaft 23. FIG. 16 to FIG. 18 are drawings illustrating the pod according to a modified example.

A pod 40A illustrated in FIG. 16 according to the modified example includes a first pod 401 and a second pod 402. As illustrated in FIG. 16, the first pod 401 is a cylindrical member extending along the axial direction of the rotation shaft 23 of the rotor 20. Different from the pod 40, the first pod 401 does not include the large diameter portion 42 and the small diameter portion 43 and extends along the axial direction with a fixed diameter. The second pod 402 is fixed to an upper end portion of the first pod 401. The second pod 402 is a cylindrical member extending along the axial direction of the rotation shaft 23 of the rotor 20. An inner space of the second pod 402 is filled with gas. With this, in addition to the buoyancy B that acts on the apparatus main body 10 by the gas filled in an inner space of the first pod 401, a buoyancy acts on the apparatus main body 10 also by the gas filled in the inner space of the second pod 402. As a result, it is possible to dispose the center of buoyancy 10B of the apparatus main body 10 on a vertical upper side with respect to the center axis 23a of the rotation shaft 23. Moreover, as compared with a case where the second pod 402 (namely, a float portion) is disposed on the upper portion of the apparatus main body 10 with a shaft interposed therebetween, it is possible to intend to simplify the apparatus. Furthermore, since the center of buoyancy 10B can be disposed on a vertical upper side with respect to the center of gravity 10G without disposing a ballast section on a lower portion of the apparatus main body 10 with a shaft interposed therebetween, it is possible to intend to simplify the apparatus.

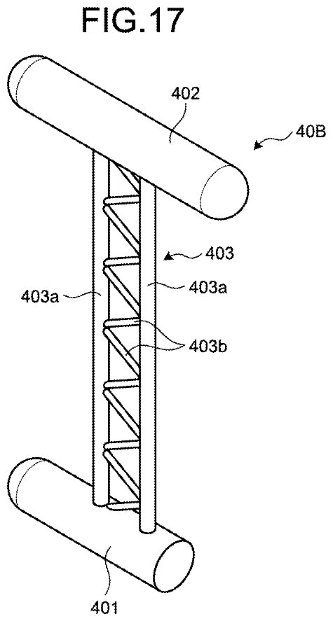

A pod 40B illustrated in FIG. 17 according to the modified example includes a connecting member 403 connected between the first pod 401 and the second pod 402 in addition to the constitution of the pod 40A illustrated in FIG. 16. As illustrated in FIG. 17, the connecting member 403 includes a pair of rod-like members 403a extending along the vertical direction between the first pod 401 and the second pod 402 and a plurality of supporting members 403b extending between the pair of rod-like members 403a. The supporting members 403b are provided in order to improve the rigidity of the connecting member 403. With this, since the second pod 402 can be disposed on a vertically more upper side, it is possible to dispose the center of buoyancy 10B of the apparatus main body 10 on a vertically more upper side. Even in this case, since the center of buoyancy 10B can be disposed on a vertical upper side with respect to the center of gravity 10G without disposing a ballast portion at a lower portion of the apparatus main body 10 with a shaft interposed therebetween, it is possible to intend to simplify the apparatus.

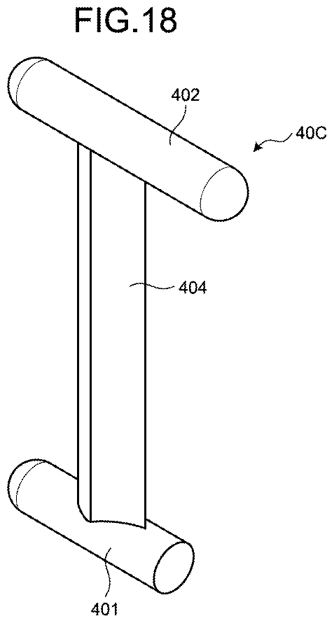

A pod 40C illustrated in FIG. 18 according to the modified example includes a connecting member 404 in place of the connecting member 403 of the apparatus main body 10 illustrated in FIG. 17. As illustrated in FIG. 18, the connecting member 404 is an integrated pillar-shaped member extending along the vertical direction between the first pod 401 and the second pod 402. By making the connecting member 404 the integrated pillar-shaped member, as compared with the connecting member 403, the rigidity of the connecting member 404 can be improved more.

Moreover, in the water-flow power generating apparatus 100 according to the first embodiment and the water-flow power generating apparatus 200 according to the second embodiment, the apparatus main body 10 has been assumed such that the center of buoyancy 10B is disposed on a vertical upper side with respect to the center axis 23a of the rotation shaft 23 of the rotor 20 and the center of gravity 10G is disposed on a vertical lower side with respect to the center axis 23a of the rotation shaft 23 of the rotor 20. However, when the apparatus main body 10 inclines due to the reaction torque T1, as long as the rotation torque T2 acts on the apparatus main body 10 by the buoyancy B acting at the center of buoyancy 10B and the gravity G acting at the center of gravity 10G, the positional relation between the center of buoyancy 10B and the center of gravity 10G is not limited to this. For example, the center of gravity 10G may be disposed on a vertical lower side with respect to the center axis 23a of rotation shaft 23, and the center of buoyancy 10B may be disposed at a position where the center of buoyancy 10B is in line with the center axis 23a of the rotation shaft 23 in the vertical direction. Moreover, the center of buoyancy 10B may be disposed on a vertical upper side with respect to the center axis 23a of the rotation shaft 23, and the center of gravity 10G may be disposed at a position where the center of gravity 10G is in line with the center axis 23a of the rotation shaft 23 in the vertical direction. Moreover, the center of buoyancy 10B, the center of gravity 10G, and the center axis 23a of the rotation shaft 23 is not necessarily disposed on a straight line.

In this connection, when the apparatus main body 10 inclines in the acting direction of the reaction torque T1 due to the action of the reaction torque T1, as long as the resultant force of the above-described rotation torque T2 and rotation torque TF balances with the reaction torque T1 and the attitude of the apparatus main body 10 can be maintained, the first connecting mechanism 61 and the second connecting mechanism 62 may be disposed at any position of the pod 40.

### Third Embodiment

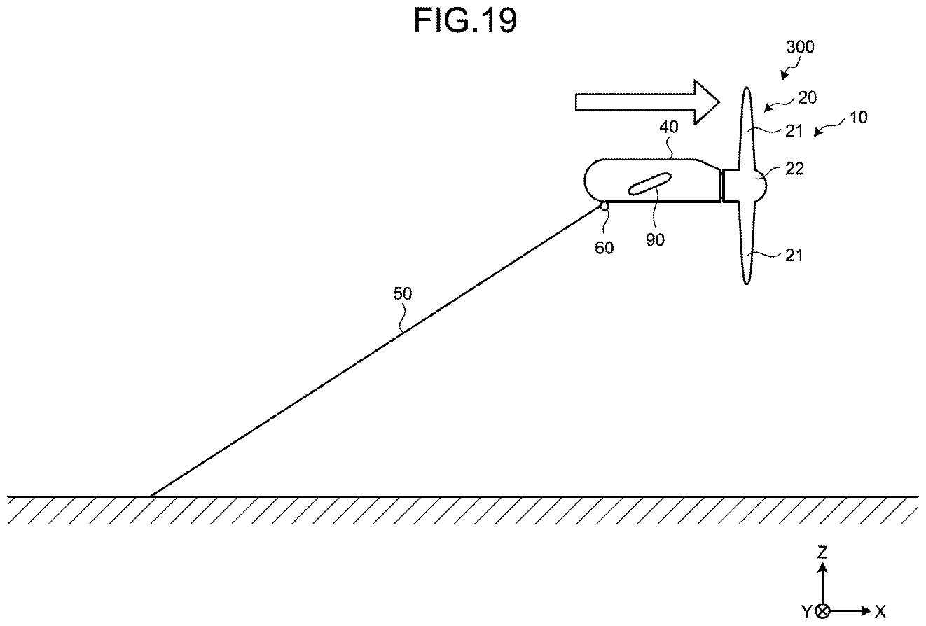

Next, a water-flow power generating apparatus 300 according to the third embodiment will be described. FIG. 19 is a schematic drawing illustrating a water-flow power generating apparatus according to the third embodiment. The water-flow power generating apparatus 300 includes a plurality of wing portions 90 attached to the pod 40. Since the other constitutions of the water-flow power generating apparatus 300 are the same as those of the water-flow power generating apparatus 100 according to the first embodiment, description for them is omitted.

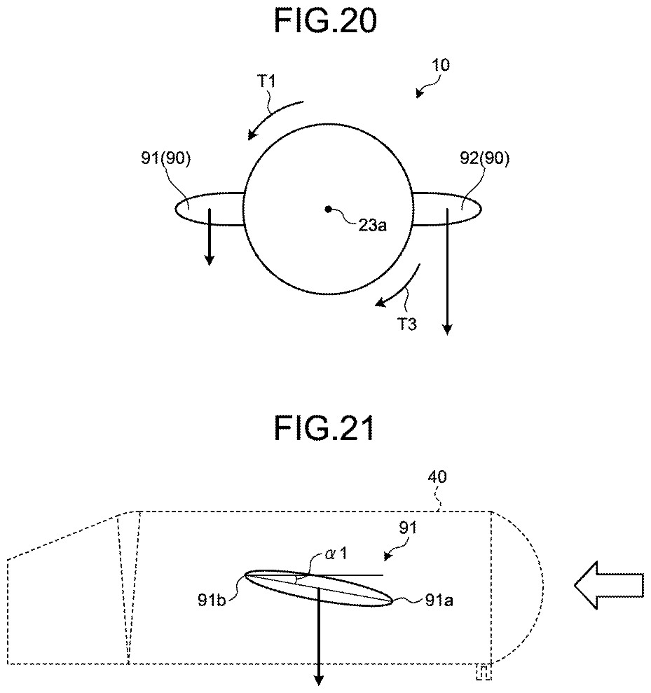

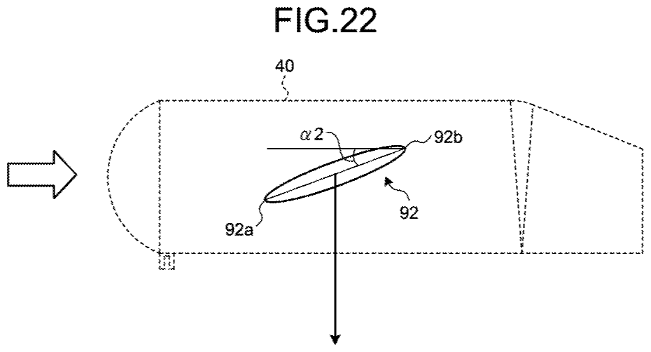

FIG. 20 is a schematic drawing of an apparatus main body of the water-flow power generating apparatus according to the third embodiment when viewed from its front side. In this connection, in FIG. 20, in order to simplify the description, description for each constitution element of the apparatus main body 10 is omitted, and the apparatus main body 10 is illustrated schematically with a circle form. As illustrated in FIG. 20, the wing portions 90 include a first wing portion 91 attached to one side surface of the apparatus main body 10 and a second wing portion 92 attached to the other side surface of the apparatus main body 10. Hereinafter, specific constitutions of the first wing portion 91 and the second wing portion 92 will be described, while referring to the drawings. FIG. 21 is a sectional view illustrating the first wing portion, and FIG. 22 is a sectional view illustrating the second wing portion.

The first wing portion 91 is attached to one side surface of the pod 40 (refer to a broken line in FIG. 21). In the present embodiment, as illustrated in FIG. 21, the first wing portion 91 is a wing that is vertically symmetrical. In the first wing portion 91, a leading edge 91a is positioned on a vertical lower side with respect to a trailing edge 91b. That is, the first wing portion 91 has an angle of attack α1 that, upon receiving a water flow flowing in a direction indicated with a white arrow in the drawing, generates a force in a vertically downward direction as indicated with a solid line arrow in the drawing.

The second wing portion 92 is attached to the other side surface of the pod 40 (refer to a broken line in FIG. 22). In the present embodiment, as illustrated in FIG. 22, the second wing portion 92 is a wing that is vertically symmetrical, similarly to the first wing portion 91. In the second wing portion 92, a leading edge 92a is positioned on a vertical lower side with respect to a trailing edge 92b. That is, the second wing portion 92 has an angle of attack α2 that, upon receiving a water flow flowing in a direction indicated with a white arrow in the drawing, generates a force in a vertically downward direction as indicated with a solid line arrow in the drawing. Moreover, as illustrated in FIG. 21 and FIG. 22, the angle of attack α2 of the second wing portion 92 is set to be larger than the angle of attack α1 of the first wing portion 91. Thereby, a force in the vertical downward direction acting on the second wing portion 92 becomes larger than a force in the vertically downward direction acting on the first wing portion 91.

With this, as illustrated in FIG. 20, the apparatus main body 10 receives a force in a vertically downward direction from the first wing portion 91 and the second wing portion 92. As mentioned in the above, since the force in the vertically downward direction acting on the second wing portion 92 is larger than the force in the vertically downward direction acting on the first wing portion 91, rotation torque T3 in the rotation direction of the rotor 20, i.e., in a direction opposite to the reaction torque T1 acts on the apparatus main body 10. Therefore, in the case where the resultant force of the rotation torque T2 by the buoyancy B and the gravity G having been described in the first embodiment, the rotation torque TF by the force F based on the tension of the mooring cable 50, and the rotation torque T3, balances with the reaction torque T1, the attitude of the apparatus main body 10 is maintained in the water. Thereby, it becomes possible to suppress the apparatus main body 10 from rotating in the water due to the reaction torque T1, inclining by a predetermined angle (for example 90°) or more, and becoming unable to stay stably in the water. Moreover, in addition to the rotation torque T2 and the rotation torque TF, by making the rotation torque T3 act, it becomes possible to make the inclination angle θ of the apparatus main body 10 smaller.

Moreover, when the apparatus main body 10 has been initially disposed in the water and has received a water flow, the apparatus main body 10 receives a force in a vertically downward direction from the first wing portion 91 and the second wing portion 92 and moves to a vertical lower side until it reaches a position where it can stay stably in the water. Thereby, the water-flow power generating apparatus 300 of the third embodiment can move promptly the apparatus main body 10 having been initially disposed in the water to a position where it can stay stably in the water.

As described in the above, in the water-flow power generating apparatus 300 according to the third embodiment, the apparatus main body 10 includes the wing portions 90 that are attached to the pod 40 and make the rotation torque T3 of the rotation direction of the rotor 20 act on the apparatus main body 10 by a force received from a water flow. With this, by the rotation torque T3 that acts on the apparatus main body 10 in the rotation direction of the rotor 20, i.e., the direction opposite to the reaction torque T1, it is possible to prevent the apparatus main body 10 from rotating due to the reaction torque T1. Therefore, with respect to the water-flow power generating apparatus 300 that generates electricity by the rotation of a single rotor 20, it is possible to maintain the attitude of the apparatus main body 10 stably in the water.

Moreover, the wing portions 90 make the force in the vertically downward direction act on the apparatus main body 10. With this, by the force from the wing portions 90, it is possible to make the apparatus main body 10 move to a vertical lower side and to locate promptly the apparatus main body 10 at a position where it stays most stably in the water.

In this connection, the constitutions of the first wing portion 91 and the second wing portion 92 are not limited to those illustrated in FIG. 21 and FIG. 22. The first wing portion 91 and the second wing portion 92 only need to be able to make the rotation torque T3 act on the apparatus main body 10 by receiving a water flow by adjusting their shapes, the angle of attack α1, and the angle of attack α2 and to be able to make a force in a vertically downward direction act on the apparatus main body 10. For example, the first wing portion 91 and the second wing portion 92 may be made a vertically asymmetric wing that exhibits a protruding shape on a vertical lower side and may be made to generate a force in a vertically downward direction when receiving a water flow. In this case, in the case where the protruding shape of the second wing portion 92 is formed to be larger than the protruding shape of the first wing portion 91, even if the angle of attack α1 of the first wing portion 91 and the angle of attack α2 of the second wing portion 92 are made the same value, it is possible to make the rotation torque T3 act on the apparatus main body 10. In that case, the angle of attack α1 and the angle of attack α2 may be set as the value 0 (deg).

Moreover, as long as the first wing portion 91 and the second wing portion 92 can make the rotation torque T3 act on the apparatus main body 10 by receiving a water flow, the first wing portion 91 and the second wing portion 92 is not necessarily one that makes a force in a vertically downward direction act on the apparatus main body 10.

Moreover, the wing portions 90 may include three or more wing portions. Furthermore, in the wing portions 90, a wing portion to make the rotation torque T3 act on the apparatus main body 10 and a wing portion to make a force in a vertically downward direction act on the apparatus main body 10 may be attached as different members to the pod 40.

In the third embodiment, although it has been assumed that the wing portions 90 are added to the constitution of the water-flow power generating apparatus 100 according to the first embodiment, the wing portions 90 may be added to the constitution of the water-flow power generating apparatus 200 according to the second embodiment. Moreover, as long as the reaction torque T1 can be cancelled with the rotation torque T3 by the wing portions 90 and the attitude of the apparatus main body 10 can be maintained, when the apparatus main body 10 inclines due to the action of the reaction torque T1, the apparatus main body 10 is not necessarily one that makes the rotation torque T2 act on itself by the buoyancy B acting on the center of buoyancy 10B and the gravity G acting on the center of gravity 10G. In concrete terms, the center of buoyancy 10B and the center of gravity 10G may be disposed at a position that coincides with the center axis 23a of the rotation shaft 23 of the rotor 20.

### REFERENCE SIGNS LIST

10 Apparatus main body
10B Center of buoyancy
10G Center of gravity
20 Rotor
21 Blade
22 Rotor head
23 Rotation shaft
23a Center axis
30 Internal component
31 Power generator
32 Supporting member
32a First supporting member
32b Second supporting member
40, 40A, 40B, 40C Pod
40a Opening portion
401 First pod
402 Second pod
403, 404 Connecting member
403a Rod-like member
403b Supporting member
41 Head portion
42 Large diameter portion
43 Small diameter portion
50 Mooring cable
51 First mooring cable
52 Second mooring cable
53 Auxiliary cable
60 Connecting mechanism
61 First connecting mechanism
611, 621 Pair of protruding portions
611a, 621a Through hole
612, 622 Flat plate portion
613, 623 Pin
62 Second connecting mechanism
70 Fixing portion
80 Rod-like member
90 Wing portion
91 First wing portion
91a Leading edge
91b Trailing edge
92 Second wing portion
92a Leading edge
92b Trailing edge
100, 200, 200A, 300 Water-flow power generating apparatus

1. A water-flow power generating apparatus for generating electricity by a force of a water flow when disposed in water, the water-flow power generating apparatus comprising:
an apparatus main body including one rotor configured to rotate by a force received by a plurality of blades from a water flow, a generator connected to a rotation shaft of the rotor to generate electricity by a rotation force of the rotor, and a pod that accommodates the generator;
a mooring cable for mooring the apparatus main body to a bottom of water; and
a connecting mechanism for connecting the mooring cable to the pod, wherein
the connecting mechanism connects the mooring cable and the pod so that the mooring cable and the pod are relatively movable along a vertical plane orthogonal to a center axis of the rotation shaft of the rotor,
the pod includes a head portion, a large diameter portion extending along an axial direction from the head portion, a small diameter portion extending from the large diameter portion while reducing the diameter, and an opening portion at an end of the small diameter portion on a side opposite to the head portion,
an inner space of the pod is filled with gas,
a center of the opening portion coincides with the center axis of the rotation shaft, a lower end of the small diameter portion extends horizontally with the lower end of the large diameter portion,
on portions other than the lower end, the small diameter portion exhibits a tapered shape in which an outside diameter gradually reduces from the large diameter portion toward the opening portion, and
a center of buoyancy of the apparatus main body is on a vertical upper side with respect to a center of gravity of the apparatus main body.

2. The water-flow power generating apparatus according to claim 1, wherein in the apparatus main body, the center of buoyancy is on a vertical upper side with respect to the center axis of the rotation shaft of the rotor.

3. The water-flow power generating apparatus according to claim 2, wherein in the apparatus main body, the center of gravity is disposed on a vertical lower side with respect to the center axis of the rotation shaft of the rotor.

4. The water-flow power generating apparatus according to claim 2, wherein in the pod, an inner space on a vertical upper side with respect to the center axis of the rotation shaft of the rotor is wider than an inner space on a vertical lower side with respect to the center axis of the rotation shaft.

5. The water-flow power generating apparatus according to claim 1, wherein
the mooring cable includes a plurality of first mooring cables to be fixed to the bottom of water at respective positions separated from each other in a direction orthogonal to a water-flow direction among horizontal directions, and
the connecting mechanism includes a first connecting mechanism for connecting the plurality of first mooring cables at a same position of the pod.

6. The water-flow power generating apparatus according to claim 5, wherein
the mooring cable further includes a second mooring cable,
the connecting mechanism includes a second connecting mechanism for connecting the second mooring cable to the pod on a side closer to the plurality of blades than to the first connecting mechanism, and
the first connecting mechanism and the second connecting mechanism are disposed at respective positions that overlap with each other when viewed from an axial direction of the rotation shaft.

7. The water-flow power generating apparatus according to claim 6, further comprising an auxiliary cable connected to the pod on a side opposite to the plurality of blades with respect to the second connecting mechanism and fixed to the second mooring cable.

8. The water-flow power generating apparatus according to claim 7, wherein a relative position between a connecting portion of the auxiliary cable and the pod and a fixing portion of the auxiliary cable and the second mooring cable is adjustable.

9. The water-flow power generating apparatus according to claim 1, wherein the apparatus main body includes a plurality of wing portions that are attached to the pod to make rotation torque of the rotation direction of the rotor act on the apparatus main body by a force received from a water flow.

10. The water-flow power generating apparatus according to claim 9, wherein the plurality of wing portions make a force in a vertically downward direction act on the apparatus main body.

11. The water-flow power generating apparatus according to claim 1, wherein an internal component is accommodated in the pod, and the internal component is fixed to a lower surface of the pod through a first supporting member attached to the lower surface, and is fixed to a side surface of the pod through a second supporting member attached to the side surface.

12. The water-flow power generating apparatus according to claim 8, further comprising a rod-like member connected between the fixing portion of the auxiliary cable and the second mooring cable and the second connecting mechanism.
